(19) United States
(12) Patent Application Publication
(10) Pub. No.: US 2006/0145955 A1
(43) Pub. Date: Jul. 6, 2006

(54) Plasma display apparatus and driving method thereof

(75) Inventor: Jeong Pil Choi, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/296,362

(22) Filed: Dec. 8, 2005

(30) Foreign Application Priority Data
Dec. 31, 2004 (KR) 10-2004-0118249

(51) Int. Cl. G09G 3/28

(52) U.S. Cl. 345/67

(57) ABSTRACT

The present invention relates to a plasma display apparatus and driving method thereof. The plasma display apparatus according to the present invention comprises a plasma display panel comprising a scan electrode and a sustain electrode, a scan driver that applies a first falling pulse, which falls up to a first voltage, to the scan electrode during a reset period, and applies a scan pulse to the scan electrode during an address period, and a sustain driver that supplies a positive voltage to the sustain electrode, and then applies a second falling pulse, which falls up to a second voltage, to the sustain electrode during the latter half period of the reset period.

This Nonprovisional application claims priority under 35 U.S.C. § 119(a) on Patent Application No. 10-2004-0118249 filed in Korea on Dec. 31, 2005 the entire contents of which are hereby incorporated by reference.

### BACKGROUND OF THE INVENTION

1. Field of the Invention

The present invention relates to a plasma display apparatus and driving method thereof.

2. Description of the Background Art

In general, a plasma display panel displays images comprising characters and/or graphics by light-emitting phosphors with ultraviolet rays of 147 nm generated during the discharge of a mixed inert gas such as He+Xe, Ne+Xe or He+Ne+Xe.

FIG. 1 is a perspective view illustrating the construction of a three-electrode AC surface discharge type plasma display panel in the related art.

As shown in FIG. 1, the three-electrode AC surface discharge type plasma display apparatus in the related art comprises a scan electrode 11 and a sustain electrode 12 formed on an upper substrate 10, and an address electrode 22 formed on a lower substrate 20. The scan electrode 11 and the sustain electrode 12 comprises a transparent electrode, e.g. Indium Tin Oxide (ITO) 11a, 12a, respectively. In the scan electrode 11 and the sustain electrode 12 are respectively formed bus electrodes 11b, 12b for reducing resistance. An upper dielectric layer 13a and a protection film 14 are laminated on the upper substrate 10 on which the scan electrode 11 and the sustain electrode 12 are formed. Wall charges generated during the discharge of plasma are accumulated on the upper dielectric layer 13a. The protection film 14 functions to prevent damage to the upper dielectric layer 13a by sputtering generated during the discharge of plasma and also to improve emission efficiency of secondary electrons. The protection layer 14 is generally formed using magnesium oxide (MgO).

A lower dielectric layer 13b and barrier ribs 21 are formed on the lower substrate 20 on which the address electrode 22 is formed. A phosphor layer 23 is coated on the surfaces of the lower dielectric layer 13b and the barrier ribs 21. The address electrode 22 are formed to cross the scan electrodes 11 and the sustain electrodes 12. The barrier ribs 21 are formed parallel to the address electrode 22 and function to prevent ultraviolet rays generated during the discharge and a visible ray from leaking to neighboring discharge cells. The phosphor layer 23 is excited with ultraviolet rays generated during the discharge of plasma to generate any one visible ray of red, green and blue. An inert mixed gas, such as He+Xe or Ne+Xe for discharge, is injected into discharge spaces of a discharge cell, which are provided between the upper and lower substrates 10, 20 and the barrier ribs 21. A method of representing image gray level of the plasma display panel constructed above in the related art will be described below with reference to FIG. 2.

FIG. 2 is a view illustrating a method of representing image gray level of the plasma display panel in the related art. As shown in FIG. 2, in order to implement image gray levels, the plasma display panel is driven with one frame being divided into several sub-fields with a different number of emissions. Each sub-field is divided into a reset period for uniformly generating a discharge, an address period for selecting a cell to be discharged, and a sustain period for implementing gray levels depending on the number of discharges. For example, if it is sought to display images with 256 gray levels, a frame period (16.67 ms) corresponding to 1/60 seconds is divided into eight sub-fields SF1 to SF8, as shown in FIG. 2. Each of the eight sub-fields is again divided into a reset period, an address period and a sustain period. The reset period and the address period of each sub-field are the same every sub-field, whereas the sustain period thereof is increased in the ratio of 2ⁿ (where, n=0,1,2,3,4,5,6,7) in each sub-field. A driving pulse depending on the method of driving the plasma display panel will be described below with reference to FIG. 3.

FIG. 3 shows a driving pulse depending on a method of driving the plasma display panel in the related art. As shown in FIG. 3, the plasma display panel is driven with it being divided into a reset period for initializing the entire cells, an address period for selecting a cell to be discharged, a sustain period for sustaining the discharge of a selected cell and an erase period for erasing wall charges within a discharged cell.

In a set-up period of the reset period, a ramp-up pulse (Ramp-up) is applied to the entire scan electrodes Y at the same time. The ramp-up pulse generates a discharge within the discharge cells of the entire screen. The ramp-up discharge also causes positive (+) wall charges to be accumulated on the address electrodes X and the sustain electrodes Z, and negative (−) wall charges to be accumulated on the scan electrodes Y. In a set-down period of the reset period, after the ramp-up pulse is applied, a ramp-down pulse (Ramp-down), which begins falling from a positive (+) voltage lower than a peak voltage of the ramp-up pulse to a predetermined voltage level (−Vw) lower than a ground (GND) level voltage, generates a weak erase discharge within the cells, thereby sufficiently erasing wall charges that are excessively formed on the scan electrodes Y. The set-down discharge causes wall charges of the degree in which an address discharge can be stably generated to uniformly remain within the cells.

In the address period, while a scan pulse (Scan) of a negative (−) voltage (−Vy) is sequentially applied to the scan electrodes Y, a data pulse (data) of a positive (+) voltage is applied to the address electrodes X in synchronization with the scan pulse. As a voltage difference between the scan pulse and the data pulse and a wall voltage generated in the reset period are added, an address discharge is generated within the discharge cell to which the data pulse is applied. Furthermore, wall charges of the degree in which a discharge can be generated when a sustain voltage (Vs) is applied are formed within a cell selected by the address discharge. During the set-down period and the address period, the sustain electrodes Z are supplied with a positive (+) voltage (Vz) such that an erroneous discharge is not generated between the sustain electrodes Z and the scan electrodes Y by reducing a voltage difference between the sustain electrodes Z and the scan electrodes Y.

In the sustain period, a sustain pulse (Sus) is alternately applied to the scan electrodes Y and the sustain electrodes Z. As a wall voltage within the cell and the sustain pulse are added, a sustain discharge, i.e., a display discharge is generated between the scan electrodes Y and the sustain electrodes Z in cells selected by an address discharge whenever the sustain pulse (Sus) is applied.

After the sustain discharge is completed, in the erase period, a voltage of an erase ramp pulse (Ramp-ers) having a narrow pulse width and a low voltage level is applied to the sustain electrodes Z, thereby erasing wall charges remaining within the cells of the entire screen.

Meanwhile, change in wall charges in the reset period of the plasma display panel in the related art, which is driven as described above, will be described below with reference to FIG. 4.

FIG. 4 is a view illustrating change in wall charges in a reset period of the plasma display panel in the related art. Referring to FIG. 4, FIG. 4(a) shows a wall charge state in the set-up period of the reset period, and FIG. 4(b) shows a wall charge state in the set-down period of the reset period. As the ramp-up pulse is applied to the scan electrode Y in the set-up period, negative wall charges are accumulated on the scan electrode Y, and positive wall charges are accumulated on the sustain electrode Z and the address electrode X. Thereafter, as the ramp-down pulse is applied to the scan electrode Y in the set-down period, the polarity of the voltage is reversed and wall charges, which are excessively and irregularly formed, are reduced by some amount. At this time, a dark discharge degrading a contrast characteristic is generated. In general, a discharge that degrades a contrast characteristic is a surface discharge occurring in the entire cell area through the transparent electrode between the scan electrode Y and the sustain electrode Z. For this reason, in the plasma display panel of the related art, an attempt has been made to improve the contrast characteristic by reducing the surface discharge between the scan electrode Y and the sustain electrode Z in such a manner that a level (−Vw) of a specific voltage where the set-down period is ended is set to be higher than the negative (−) voltage (−Vy) where the scan pulse is applied to the scan electrodes Y of the address period when the plasma display panel is driven.

However, to set the level (−Vw) of a specific voltage where the set-down period is ended to be higher than the negative (−) voltage (−Vy) where the scan pulse is applied to the scan electrodes Y of the address period, an additional voltage source (−Vw) must be provided or an operating circuit that prevents a voltage from falling at the level (−Vw) of a specific voltage must be added. Therefore, a problem arises because the manufacturing cost is increased.

### SUMMARY OF THE INVENTION

Accordingly, an object of the present invention is to solve at least the problems and disadvantages of the background art.

It is an object of the present invention to provide a plasma display apparatus and driving method thereof, in which driving margin when a plasma display panel is driven can be secured and current and heat characteristics due to deviation in components of a switching element can be improved.

A plasma display apparatus according to an aspect of the present invention comprises a plasma display panel comprising a scan electrode and a sustain electrode, a scan driver that applies a first falling pulse, which falls up to a first voltage, to the scan electrode during a reset period, and applies a scan pulse to the scan electrode during an address period, and a sustain driver that supplies a positive voltage to the sustain electrode, and then applies a second falling pulse, which falls up to a second voltage, to the sustain electrode during the latter half period of the reset period.

A plasma display apparatus according to another aspect of the present invention comprises a plasma display panel comprising a scan electrode and a sustain electrode, a scan driver that supplies a first falling pulse, which falls up to a first voltage and then keeps during a predetermined period, to the scan electrode during a reset period, and applies a scan pulse to the scan electrode during an address period, and a sustain driver that supplies a positive voltage to the sustain electrode and then supplies a second falling pulse, which falls up to a second voltage during a first period and then keeps during a second period.

According to still another aspect of the present invention, there is provided a method of driving a plasma display apparatus in which a plurality of sub-fields is driven with each being divided into a reset period, an address period and a sustain period, comprising the steps of supplying a first falling pulse, which falls up to a first voltage, to a scan electrode during the reset period, and supplying a positive voltage to a sustain electrode and then supplying a second falling pulse, which falls up to a second voltage, to the sustain electrode during a latter half period of the reset period, and supplying a scan pulse to the scan electrode during the address period.

The present invention are advantageous in that it can improve irregularity of current and heat characteristics due to deviation in components of a switching element and a difference in driving characteristics thereof and can also improve driving margin, when a plasma display panel is driven.

### BRIEF DESCRIPTION OF THE DRAWINGS

The invention will be described in detail with reference to the following drawings in which like numerals refer to like elements.

FIG. 1 is a perspective view illustrating the construction of a three-electrode AC surface discharge type plasma display panel in the related art;

FIG. 2 is a view illustrating a method of representing image gray level of the plasma display panel in the related art;

FIG. 3 shows a driving pulse depending on a method of driving the plasma display panel in the related art;

FIG. 4 is a view illustrating change in wall charges in a reset period of the plasma display panel in the related art;

FIG. 5 is a block diagram of a plasma display apparatus according to an embodiment of the present invention;

FIG. 6 is a view illustrating a first driving method of the plasma display apparatus according to an embodiment of the present invention;

FIG. 7 is a view illustrating a second driving method of the plasma display apparatus according to an embodiment of the present invention; and

FIG. 8 is a view illustrating a third driving method of the plasma display apparatus according to an embodiment of the present invention.

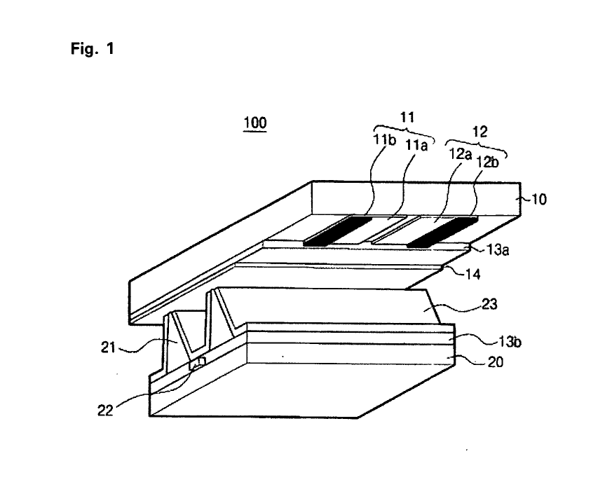

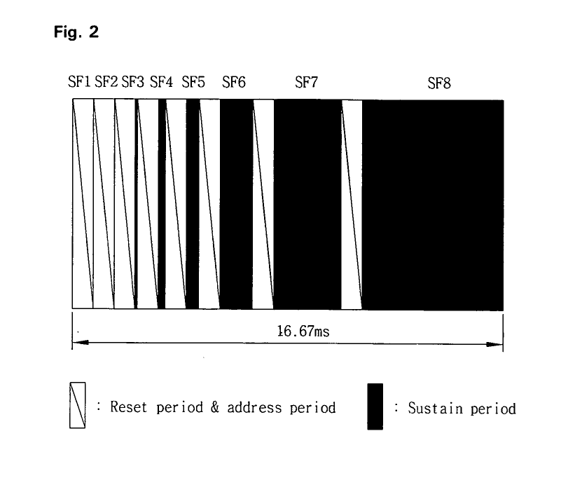

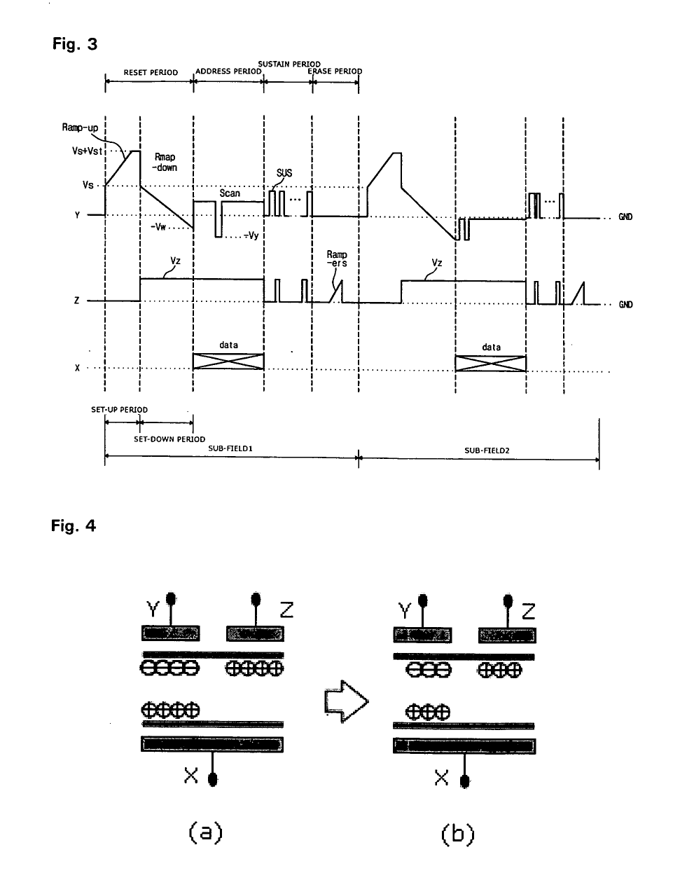

### DETAILED DESCRIPTION OF PREFERRED EMBODIMENTS

Preferred embodiments of the present invention will be described in a more detailed manner with reference to the drawings.

A plasma display apparatus according to the present invention comprises a plasma display panel comprising a scan electrode and a sustain electrode, a scan driver that applies a first falling pulse, which falls up to a first voltage, to the scan electrode during a reset period, and applies a scan pulse to the scan electrode during an address period, and a sustain driver that supplies a positive voltage to the sustain electrode, and then applies a second falling pulse, which falls up to a second voltage, to the sustain electrode during the latter half period of the reset period.

The second falling pulse is a ramp pulse having a slant.

The slant of the second falling pulse is the same as that of the first falling pulse.

The latter half period of the reset period is set in the range of 1 μs to 50 μs.

The second falling pulse is formed as the sustain electrode is floated.

The first voltage is the same as a voltage of the scan pulse.

The first voltage is higher than a voltage of the scan pulse.

A plasma display apparatus according to the present invention comprises a plasma display panel comprising a scan electrode and a sustain electrode, a scan driver that supplies a first falling pulse, which falls up to a first voltage and then keeps during a predetermined period, to the scan electrode during a reset period, and applies a scan pulse to the scan electrode during an address period, and a sustain driver that supplies a positive voltage to the sustain electrode and then supplies a second falling pulse, which falls up to a second voltage during a first period and then keeps during a second period.

The first voltage is the same as a voltage of the scan pulse.

The second falling pulse is a ramp pulse having a slant.

The second falling pulse has the same slant as that of the first falling pulse.

The second period of the second falling pulse is the same as a predetermined period where the first falling pulse is kept.

A second period of the second falling pulse is set in the range of 1 μs to 50 μs.

The second falling pulse is formed as the sustain electrode is floated.

According to still another aspect of the present invention, there is provided a method of driving a plasma display apparatus in which a plurality of sub-fields is driven with each being divided into a reset period, an address period and a sustain period, comprising the steps of supplying a first falling pulse, which falls up to a first voltage, to a scan electrode during the reset period, and supplying a positive voltage to a sustain electrode and then supplying a second falling pulse, which falls up to a second voltage, to the sustain electrode during a latter half period of the reset period, and supplying a scan pulse to the scan electrode during the address period.

Detailed embodiments of the present invention will now be described in connection with reference to the accompanying drawings.

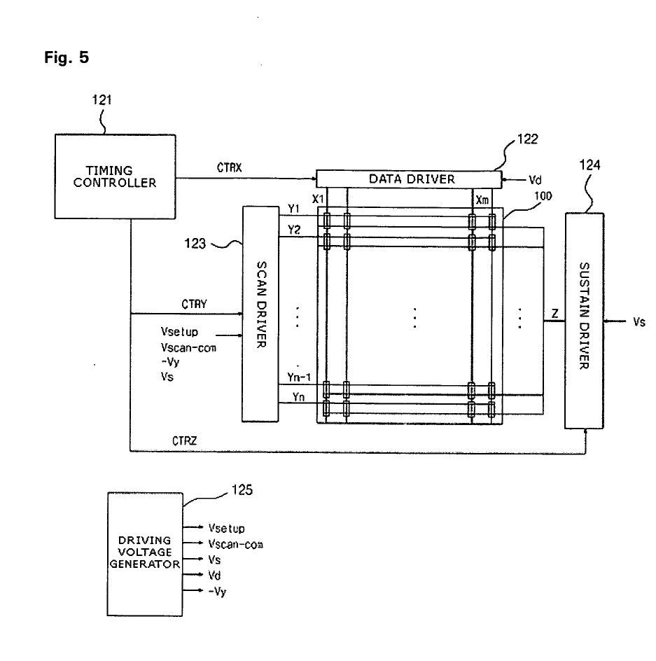

FIG. 5 is a block diagram of a plasma display apparatus according to an embodiment of the present invention. Referring to FIG. 5, the plasma display apparatus according to an embodiment of the present invention comprises a plasma display panel 100, a data driver 122 for supplying data to address electrodes X1 to Xm formed in a lower substrate (not shown) of the plasma display panel 100, a scan driver 123 for driving scan electrodes Y1 to Yn, a sustain driver 124 for driving sustain electrodes Z (i.e., a common electrode), a timing controller 121 for controlling the data driver 122, the scan driver 123 and the sustain driver 124 when the plasma display panel is driven, and a driving voltage generator 125 for supplying driving voltages necessary for the drivers 122, 123 and 124 thereto.

The plasma display panel 100 comprises an upper substrate (not shown) and a lower substrate (not shown), which are coalesced with a predetermined distance therebetween. A number of electrodes, such as the scan electrodes Y1 to Yn and the sustain electrodes Z, is formed in pairs in the upper substrate. The address electrodes X1 to Xm are formed to cross the scan electrodes Y1 to Yn and the sustain electrodes Z in the lower substrate.

The data driver 122 is supplied with data, which have experienced inverse gamma correction, error diffusion and so on through an inverse gamma correction circuit (not shown), an error diffusion circuit (not shown) and the like and are then mapped to respective sub-fields by a sub-field mapping circuit. The data driver 122 samples and latches data in response to a timing control signal (CTRX) from the timing controller 121 and supplies the data to the address electrodes X1 to Xm.

The scan driver 123 supplies a ramp-up pulse (Ramp-up) and a ramp-down pulse (Ramp-down) to the scan electrodes Y1 to Yn under the control of the timing controller 121 during the reset period. The scan driver 123 also sequentially supplies a scan pulse (Sp) of a scan voltage (−Vy) to the scan electrodes Y1 to Yn during the address period under the control of the timing controller 121. The scan driver 123 comprises an energy recovery circuit (not shown), and supplies a sustain pulse, which rises up to a sustain voltage, to the scan electrodes Y1 to Yn during the sustain period under the control of the timing controller 121.

The sustain driver 124 comprises an energy recovery circuit (not shown) in the same manner as the scan driver 123, and supplies a sustain pulse (sus) to the sustain electrodes Z during the sustain period under the control of the timing controller 121. The energy recovery circuit comprised in the sustain driver 124 has the same construction as that included in the scan electrode driving unit 123. The energy recovery circuit comprised in the sustain driver 124 alternately operates with the energy recovery circuit included in the scan driver 123.

The timing controller 121 receives vertical/horizontal sync signals and a clock signal, generates timing control signals (CTRX, CTRY and CTRZ) for controlling an operating timing and synchronization of the respective drivers 122, 123 and 124 in the reset period, the address period and the sustain period, and provides the generated timing control signals (CTRX, CTRY and CTRZ) to corresponding drivers 122, 123 and 124, thus controlling the respective drivers 122, 123 and 124.

Meanwhile, the data control signal (CTRX) comprises a sampling clock for sampling data, a latch control signal, and a switching control signal for controlling an on/off time of an energy recovery circuit and a driving switch element. The scan control signal (CTRY) comprises a switching control signal for controlling an on/off time of an energy recovery circuit and a driving switch element within the scan driver 123. The sustain control signal (CTRZ) comprises a switching control signal for controlling an on/off time of an energy recovery circuit and a driving switch element within the sustain driver 124.

The driving voltage generator 125 generates a set-up voltage (Vsetup), a common scan voltage (Vscan-com), a scan voltage (−Vy), a sustain voltage (Vs), a data voltage (Vd) and the like. These driving voltages may be varied depending on the composition of a discharge gas or the structure of a discharge cell.

In the plasma display apparatus according to the present invention, images are displayed through a combination of a plurality of sub-fields, each being divided into a reset period, an address period and a sustain period.

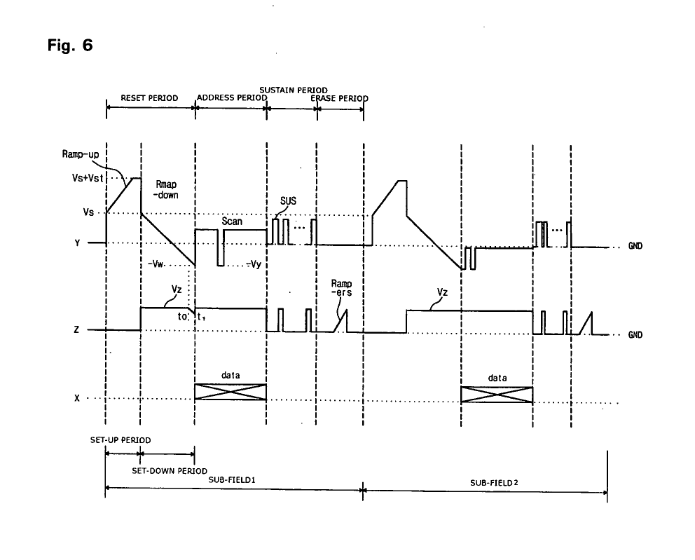

FIG. 6 is a view illustrating a first driving method of the plasma display apparatus according to an embodiment of the present invention.

As shown in FIG. 6, in the first driving method of the plasma display apparatus according to the present invention, in the reset period, a ramp-up pulse (Ramp-up) is applied to the entire scan electrodes Y at the same time, so that a set-up discharge is generated within discharge cells of the entire screen. The set-up discharge causes positive (+) wall charges to be accumulated on the address electrodes X and the sustain electrodes Z, and negative (−) wall charges to be accumulated on the scan electrodes Y. After the ramp-up pulse is applied, a first ramp-down pulse (Ramp-down), which begins falling from a positive (+) voltage lower than a peak voltage of the ramp-up pulse to a first voltage (−Vw) lower than a ground (GND) level voltage, is applied to the scan electrodes Y. At this time, the first voltage (−Vw) is the same as a voltage (−Vy) of a scan pulse supplied to the scan electrodes Y in the address period, which will be described later.

Furthermore, the sustain electrodes Z are supplied with a positive voltage (Vz) and are then supplied with a second ramp-down pulse that falls at a predetermined slant during the latter half period (t0 to t1) of the reset period. At this time, the slant of the second ramp-down pulse is set to be the same as that of the first ramp-down pulse supplied to the scan electrodes Y. The second ramp-down pulse can be generated by an additional circuit, but can be generated by performing a floating process on the sustain electrodes Z during the latter half period (t0 to t1) of the reset period. Furthermore, the period of the floating processing period (t0 to t1), i.e., the period of the latter half period (t0 to t1) of the reset period where the second ramp-down pulse supplied to the sustain electrodes Z is applied ranges from 1 μs to 50 μs.

If the floating process is performed on the sustain electrodes Z in the latter half portion of the reset period as described above, a dark discharge occurring between the scan electrodes Y and the sustain electrodes Z, i.e., a wall charge erase discharge degrading a contrast characteristic can be stopped.

In the address period, while a scan pulse (Scan) of a negative (−) voltage (−Vy) is sequentially applied to the scan electrodes Y, a data pulse (data) of a positive (+) voltage is applied to the address electrodes X in synchronization with the scan pulse. The negative voltage (−Vy) of the scan pulse is set to be the same as the first voltage (−Vw) of the first ramp-down pulse of the reset period, as described above. As a voltage difference between the scan pulse and the data pulse and a wall voltage generated in the reset period are added, an address discharge is generated within cells to which the data pulse is applied. Furthermore, wall charges of the degree in which a discharge can be generated when a sustain voltage (Vs) is applied are formed within cells selected by the address discharge. Meanwhile, the positive voltage (Vz), which is applied when the first ramp-down pulse is applied to the scan electrodes Y, is applied to the sustain electrodes Z. Therefore, an erroneous discharge is not generated between the sustain electrodes Z and the scan electrodes Y.

In the sustain period, a sustain pulse (SUS) is alternately applied to the scan electrodes Y and the sustain electrodes Z. As a wall voltage within the cell and the sustain pulse are added, a sustain discharge, i.e., a display discharge is generated between the scan electrodes Y and the sustain electrodes Z in the cells selected by the address discharge whenever the sustain pulse (SUS) is applied.

After the sustain discharge is completed, in the erase period, a voltage of an erase ramp pulse (Ramp-ers) having a narrow pulse width and a low voltage level is applied to the sustain electrodes Z, thereby erasing wall charges remaining within the cells of the entire screen.

As described above, in the first driving method of the plasma display apparatus according to the present invention, since a dark discharge occurring in the reset period is stopped, a contrast characteristic can be improved. Furthermore, the lowest voltage of the first ramp-down pulse applied to the scan electrodes and a voltage of the scan pulse supplied to the scan electrodes in the address period are set to be the same. Therefore, since an additional circuit is not required, the manufacturing cost can be saved.

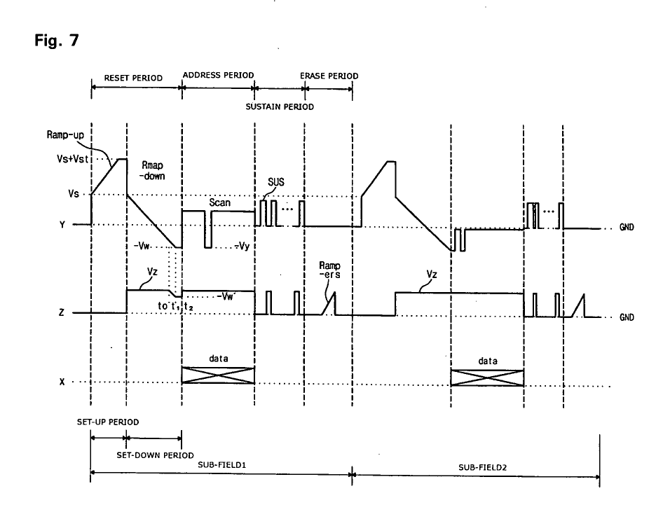

FIG. 7 is a view illustrating a second driving method of the plasma display apparatus according to an embodiment of the present invention.

As shown in FIG. 7, in the second driving method of the plasma display apparatus according to the present invention, in the reset period, a ramp-up pulse (Ramp-up) is applied to the entire scan electrodes at the same time and is then kept for a predetermined time, so that a set-up discharge is generated within discharge cells of the entire screen. The set-up discharge causes positive (+) wall charges to be accumulated on the address electrodes and the sustain electrodes, and negative (−) wall charges to be accumulated on the scan electrodes. After the ramp-up pulse is applied, a first ramp-down pulse (Ramp-down), which begins falling from a positive (+) voltage lower than a peak voltage of the ramp-up pulse to a first voltage (−Vw) lower than a ground (GND) level voltage and is then kept during a predetermined period, is applied to the scan electrodes. At this time, the first voltage (−Vw) is the same as a voltage (−Vy) of a scan pulse supplied to the scan electrodes in the address period, which will be described later.

Furthermore, the sustain electrodes are supplied with a positive voltage (Vz) and are then supplied with a second ramp-down pulse, which falls up to a second voltage (−Vw′) during a first period (t0 to t1) and is then kept during a second period (t1 to t2). At this time, the first ramp-down pulse has a constant slant, and the slant of the second ramp-down pulse is set to be the same as that of the first ramp-down pulse supplied to the scan electrodes. The second ramp-down pulse can be generated by an additional circuit, but can be generated through floating during the first period (t0 to t1) while the positive voltage (Vz) is applied to the sustain electrodes.

After floating, the second period (t1 to t2) that is constantly kept to the second voltage (−Vw′) is the same as a predetermined period of the first ramp-down pulse, which falls up to the first voltage (−Vw) and is then kept during a predetermined period in the scan electrodes. The second period (t1 to t2) of the second ramp-down pulse ranges from 1 μs to 50 μs.

If the second voltage (−Vw′) is constantly applied to the sustain electrodes during the second period (t1 to t2) as described above, not only a dark discharge occurring between the scan electrodes and the sustain electrodes, i.e., a wall charge erase discharge degrading a contrast characteristic can be stopped, but also wall charges of the degree in which an address discharge can be generated stably in a subsequent address period can be stably distributed within cells.

In the address period, while a scan pulse (Scan) of a negative (−) voltage (−Vy) is sequentially applied to the scan electrodes Y, a data pulse (data) of a positive (+) voltage is applied to the data electrodes in synchronization with the scan pulse. The negative voltage (−Vy) of the scan pulse is set to be the same as the first voltage (−Vw) of the first ramp-down pulse of the reset period, as described above. As a voltage difference between the scan pulse and the data pulse and a wall voltage generated in the reset period are added, an address discharge is generated within cells to which the data pulse is applied. Furthermore, wall charges of the degree in which a discharge can be generated when a sustain voltage (Vs) is applied are formed within cells selected by the address discharge.

Meanwhile, as the positive voltage (Vz) is applied to the sustain electrodes, an erroneous discharge is not generated between the sustain electrodes and the scan electrodes.

In the sustain period, a sustain pulse (SUS) is alternately applied to the scan electrodes and the sustain electrodes. As a wall voltage within the cell and the sustain pulse are added, a sustain discharge, i.e., a display discharge is generated between the scan electrodes and the sustain electrodes in the cells selected by the address discharge whenever the sustain pulse (SUS) is applied.

After the sustain discharge is completed, in the erase period, a voltage of an erase ramp pulse (Ramp-ers) having a narrow pulse width and a low voltage level is applied to the sustain electrodes Z, thereby erasing wall charges remaining within the cells of the entire screen.

As described above, in the second driving method of the plasma display apparatus according to the present invention, since a dark discharge occurring in the reset period is stopped, not only a contrast characteristic can be improved, but also wall charges can be stably distributed within cells. Therefore, an address discharge can be generated in the address period in a stable manner. Furthermore, in the same manner as the first embodiment of the present invention, a first voltage of the first ramp-down pulse supplied to the scan electrodes in the reset period is set to be the same as that of the scan pulse supplied to the scan electrodes in the address period. Therefore, the manufacturing cost can be saved since an additional circuit is not required.

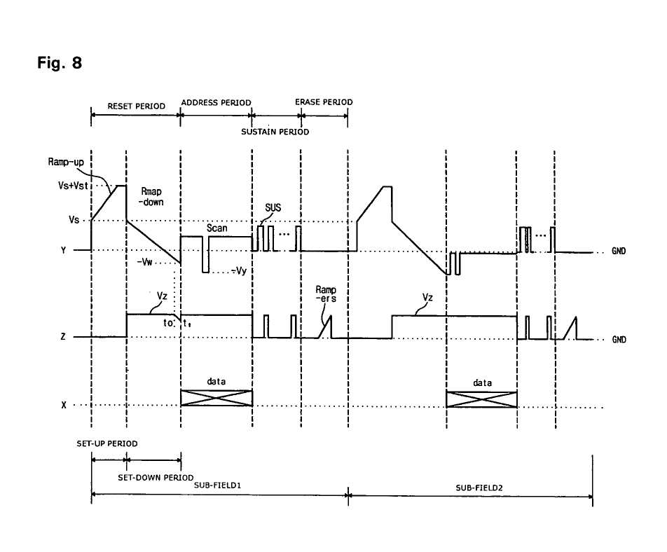

FIG. 8 is a view illustrating a third driving method of the plasma display apparatus according to an embodiment of the present invention.

As shown in FIG. 8, in the driving pulse of the plasma display panel in the third driving method of the plasma display apparatus according to the present invention, in the reset period, a ramp-up pulse (Ramp-up) is applied to the entire scan electrodes at the same time, so that a set-up discharge is generated within discharge cells of the entire screen. The set-up discharge causes positive (+) wall charges to be accumulated on the address electrodes and the sustain electrodes, and negative (−) wall charges to be accumulated on the scan electrodes. After the ramp-up pulse is applied, a first ramp-down pulse (Ramp-down), which begins falling from a positive (+) voltage lower than a peak voltage of the ramp-up pulse to a first voltage (−Vw) lower than a ground (GND) level voltage, is applied to the scan electrodes. At this time, the first voltage (−Vw) is the same as a voltage (−Vy) of a scan pulse supplied to the scan electrodes in the address period, which will be described later.

Furthermore, the sustain electrodes are supplied with a positive voltage (Vz) and are then supplied with a second ramp-down pulse that falls during the latter half period (t0 to t1) of the reset period. At this time, the slant of the second ramp-down pulse is set to be the same as that of the first ramp-down pulse supplied to the scan electrodes. The second ramp-down pulse can be generated by an additional circuit, but can be generated by keeping it floated during the latter half period (t0 to t1) of the reset period while the positive voltage (Vz) is applied to the sustain electrodes. At this time, the floating period (t0 to t1), i.e., the latter half period (t0 to t1) of the reset period of the second ramp-down pulse supplied to the sustain electrodes ranges from 1 μs to 50 μs.

If the first voltage (−Vw) of the first ramp-down pulse supplied to the scan electrodes is set to be higher than the voltage (−Vy) of the scan pulse supplied to the scan electrodes during the address period and the sustain electrodes are floated during the latter half period of the reset period, as described above, a dark discharge occurring between the scan electrodes and the sustain electrodes, i.e., a wall charge erase discharge degrading a contrast characteristic can be further stably stopped. Therefore, wall charges of the degree in which an address discharge can be generated stably in a subsequent address period can be stably distributed within cells.

In the address period, while a scan pulse (Scan) of a negative (−) voltage (−Vy) is sequentially applied to the scan electrodes Y, a data pulse (data) of a positive (+) voltage is applied to the data electrodes in synchronization with the scan pulse. The negative voltage (−Vy) of the scan pulse is set to be lower than the first voltage (−Vw) of the first ramp-down pulse of the reset period, as described above. As a voltage difference between the scan pulse and the data pulse and a wall voltage generated in the reset period are added, an address discharge is generated within cells to which the data pulse is applied. Furthermore, wall charges of the degree in which a discharge can be generated when a sustain voltage (Vs) is applied are formed within cells selected by the address discharge.

Meanwhile, as the positive voltage (Vz) is applied to the sustain electrodes, an erroneous discharge is not generated between the sustain electrodes and the scan electrodes.

In the sustain period, a sustain pulse (SUS) is alternately applied to the scan electrodes and the sustain electrodes. As a wall voltage within the cell and the sustain pulse are added, a sustain discharge, i.e., a display discharge is generated between the scan electrodes and the sustain electrodes in the cells selected by the address discharge whenever the sustain pulse (SUS) is applied.

After the sustain discharge is completed, in the erase period, a voltage of an erase ramp pulse (Ramp-ers) having a narrow pulse width and a low voltage level is applied to the sustain electrodes Z, thereby erasing wall charges remaining within the cells of the entire screen.

As described above, in the third driving method of the plasma display apparatus according to the present invention, a dark discharge occurring in the reset period is stopped. Therefore, not only a contrast characteristic can be improved, but also wall charges of the degree in which an address discharge can be stably generated in a subsequent address period can be distributed within cells in a stable manner.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

1. A plasma display apparatus comprising:
a plasma display panel comprising a scan electrode and a sustain electrode;
a scan driver for applying a first falling pulse, which falls up to a first voltage, to the scan electrode during a reset period, and applies a scan pulse to the scan electrode during an address period; and
a sustain driver for applying a positive voltage to the sustain electrode, and then applies a second falling pulse, which falls up to a second voltage, to the sustain electrode during the latter half period of the reset period.

2. The plasma display apparatus as claimed in claim 1, wherein the second falling pulse is a ramp pulse having a slant.

3. The plasma display apparatus as claimed in claim 2, wherein the slant of the second falling pulse is the same as that of the first falling pulse.

4. The plasma display apparatus as claimed in claim 1, wherein the latter half period of the reset period is set in the range of 1 μs to 50 μs.

5. The plasma display apparatus as claimed in claim 1, wherein the second falling pulse is formed as the sustain electrode is floated.

6. The plasma display apparatus as claimed in claim 1, wherein the first voltage is the same as a voltage of the scan pulse.

7. The plasma display apparatus as claimed in claim 1, wherein the first voltage is higher than a voltage of the scan pulse.

8. A plasma display apparatus comprising:
a plasma display panel comprising a scan electrode and a sustain electrode;
a scan driver for applying a first falling pulse, which falls up to a first voltage and then keeps during a predetermined period, to the scan electrode during a reset period, and applies a scan pulse to the scan electrode during an address period; and
a sustain driver for applying a positive voltage to the sustain electrode and then supplies a second falling pulse, which falls up to a second voltage during a first period and then keeps during a second period.

9. The plasma display apparatus as claimed in claim 8, wherein the first voltage is the same as a voltage of the scan pulse.

10. The plasma display apparatus as claimed in claim 8, wherein the second falling pulse is a ramp pulse having a slant.

11. The plasma display apparatus as claimed in claim 10, wherein the second falling pulse has the same slant as that of the first falling pulse.

12. The plasma display apparatus as claimed in claim 8, wherein the second period of the second falling pulse is the same as a predetermined period where the first falling pulse is kept.

13. The plasma display apparatus as claimed in claim 12, wherein a second period of the second falling pulse is set in the range of 1 μs to 50 μs.

14. The plasma display apparatus as claimed in claim 8, wherein the second falling pulse is formed as the sustain electrode is floated.

15. A method of driving a plasma display apparatus in which a plurality of sub-fields is driven with each being divided into a reset period, an address period and a sustain period, the method comprising the steps of:
applying a first falling pulse, which falls up to a first voltage, to a scan electrode during the reset period, and supplying a positive voltage to a sustain electrode and then supplying a second falling pulse, which falls up to a second voltage, to the sustain electrode during a latter half period of the reset period; and
applying a scan pulse to the scan electrode during the address period.

16. The method as claimed in claim 15, wherein the second falling pulse has the same slant as that of the first falling pulse.

17. The method as claimed in claim 15, wherein the latter half period of the reset period is set in the range of 1 μs to 50 μs.

18. The method as claimed in claim 15, wherein the second falling pulse is formed as the sustain electrode is floated.

19. The method as claimed in claim 15, wherein the first voltage is the same as a voltage of the scan pulse.

20. The method as claimed in claim 15, wherein the first voltage is higher than a voltage of the scan pulse.
